(19) United States
(12) Patent Application Publication
(10) Pub. No.: US 2015/0073632 A1
(43) Pub. Date: Mar. 12, 2015

(54) TRI-HYBRID AUTOMOTIVE POWER PLANT

(71) Applicant: Nicholas Hill, Wall, NJ (US)

(72) Inventor: Nicholas Hill, Wall, NJ (US)

(21) Appl. No.: 14/203,661

(22) Filed: Mar. 11, 2014

Related U.S. Application Data
(60) Provisional application No. 61/777,205, filed on Mar. 12, 2013.

(51) Int. Cl. B60W 20/00; B60W 10/26; B60W 10/06; B60W 10/08; H01M 8/04; H01M 10/48

(52) U.S. Cl. CPC B60W 20/10; H01M 8/04291; H01M 10/482; B60W 10/06; B60W 10/08; B60W 10/26; Y10S 903/93; Y10S 903/944
USPC 701/22; 429/450; 429/93; 903/930; 903/944; 180/65.245; 180/65.265

(57) ABSTRACT

What is disclosed is a tri-hybrid automotive power plant. The power plant is an alternative to standard internal combustion engines and available hybrid or electric vehicle propulsion systems. The power plant includes a hydrogen fuel cell stack, a lithium battery pack and a flexible fuel internal combustion engine. The various components of the power plant are optimized through various disclosed control schemes.

### PRIORITY CLAIM

This application claims priority to U.S. Provisional Application 61/777,205 filed Mar. 12, 2013

### BACKGROUND OF THE INVENTION

There have been many attempts to create a practical alternative automotive power plant to replace the gasoline powered internal combustion engine (ICE). The need to do so is obvious: gasoline is becoming increasingly expensive and the negative toll that using the fuel takes on the environment is extraordinary. To date, alternatives have not unseated the gasoline ICE because they fail to meet or exceed the latter's capability in the areas of environmental impact, safety, feasibility of refueling infrastructure, vehicle range, durability, performance and most importantly cost. It is important to study these possible replacement technologies both to understand why they are not a practical solution and because they provide a basis to understand the operation and benefit of the present Invention.

Flex-fuel engines/alternative fuels—Internal combustion engines can be configured to use a variety of alternative fuels that are either mixed with gasoline or replace the latter entirely. Most notably, biofuels, liquefied petroleum gas (LPG), compressed natural gas (CNG) and hydrogen gas have achieved some notoriety. Biofuels have not yet proven to be cost effective, make no substantial gains with regards to harmful emissions and stress agricultural infrastructure. LPG/CNG is not cost effective, makes no gains with regards to harmful emissions and is also potentially a safety hazard on board a vehicle. Hydrogen gas requires an enormous refueling infrastructure change and likewise presents a possible safety hazard on board a vehicle.

Fuel cell electric vehicles (FCEV's)—Vehicles using fuel cells face a variety of flaws. They are extremely expensive due to the materials used. Fuel cells stacks can cost $1,000 per kW or greater, so meeting the power needs of even a compact car solely with the technology is impractical. When using hydrogen gas, a refueling infrastructure change is required and again, this is a possible safety concern. Storing enough hydrogen gas to power the vehicle can also make it extremely heavy due to the need for robust tanks. Some hydrogen refueling stations even reform natural gas or petroleum based sources to produce the gas cost effectively; a practice that makes little or no progress environmentally.

Bi-polar Plate Fuel Cells—The most common fuel cell architecture in use is the bi-polar plate design. Refer to FIG. 1 to see an example of the latter. Basic operation involves flowing a fuel (in this case hydrogen gas) through the flow field on the anode side of the membrane. Oxidant (in this case oxygen gas) is flowed through the flow field on the cathode side of the membrane. The hydrogen here reacts on the anode catalyst yielding its electrons to the anode collector plate leaving the newly formed hydrogen cations to pass through the membrane and react with the oxygen gas to produce water, usually in the form of water vapor.

Note that where a flow channel does not exist on the end collector plates, shown by the thin blue and yellow arrows, valuable MEA (membrane electrode assembly) area is wasted. MEA refers to all the layers between the black collector plates and comprises the majority of cost in a fuel cell stack. Also, the membrane (center layer) actually extends beyond the entire perimeter of the rest of the MEA as do the bi-polar collector plates. This is because that excess membrane must be used to gasket chemically, and separate electrically, the two sides from each other. This means that more of the expensive MEA materials are not being used to produce power.

Hydrogen generation—Hydrogen gas can be generated very simply and cost effectively from water via electrolysis. Graphite electrodes for example, can achieve greater than 95% energy efficiencies in the process. The problem is that this efficiency drops dramatically with production rate. Recent work by Quantum Sphere Inc. and DoppStein Enterprises has greatly mitigated this problem, and via that work it is actually possible to generate hydrogen electrochemically on board a vehicle using electrical grid energy both at a practical rate and price.

Battery electric vehicles (BEV's)—Battery technology has seen significant advancement in the last two decades. Current lithium ion batteries almost make battery powered vehicles feasible. Cost however, is the biggest inhibitor of the technology and the issue of range, recharging time and availability of recharging stations makes operation impractical. To offset initial cost, some vehicles like the Nissan Leaf® use poor thermal management systems with their battery packs, so durability is sacrificed.

Hybrid electric vehicles (HEV's)—The best attempt at a practical gasoline alternative has been in hybrid vehicles. Most hybrids are the combination of a battery pack and a gasoline or flex-fuel internal combustion engine, the latter powering an electric generator. The Toyota Prius® is the most popular hybrid electric vehicle. It achieves a higher gas mileage by running the engine at a slightly heightened efficiency and letting the battery pack handle large power swings. However, the purchase price of the vehicle is still much greater than that of a gasoline equivalent and additionally, the savings via fuel economy do not offset initial higher cost. The other type of hybrid that is practical but likewise still cost ineffective is the plug-in hybrid electric vehicle (PHEV). Toyota* makes a plug in version of the Prius® and another well known car of this type is the Chevy Volt®. Both use drastically less gasoline as they have significant all electric range, but the sunk costs of the battery packs are almost impossible to gain back via the savings in fuel and maintenance expenditures over the life of the vehicle.

### SUMMARY OF THE INVENTION

A tri-hybrid automotive power plant for powering an automobile with a drive train comprising:
a) a fuel cell stack;
b) a lithium ion battery pack that is electrically connected to and charged by the fuel cell;
c) an internal combustion engine;
d) an electrical motor; and
e) a control device to determine when the fuel cell, the battery pack, the internal combustion engine or the electrical motor provides power to the drive train.

### BRIEF DESCRIPTION OF THE DRAWINGS

FIG. 1 is an illustration view of a bi-polar plate fuel cell.

FIG. 2 is a schematic illustration of a bi-polar plate alkaline fuel cell,

FIG. 3 is a schematic illustration of a bi-polar plate ethanol fuel cell.

FIG. 4 is a plan view of a cylindrical fuel cell.

FIG. 5 is an exploded view of a cylindrical fuel cell.

FIGS. 6a to 6f are schematics of various operational modes of the present invention.

FIG. 7 is a schematic view of an ejector circulator pump.

FIG. 8 is an exploded view of a prismatic fuel cell.

FIG. 9 is a schematic of a hybrid electric drive train.

FIG. 10 is a schematic for a cascaded voltage conversion drive train.

FIG. 11 is a schematic for a standard series drive train.

FIG. 12 is a schematic for a series hybrid drive train with switched DEFC.

FIG. 13 is a schematic for a voltage multiplier.

FIG. 14 is a schematic for a generator/rectifier/buck/boost converter.

FIG. 15 is a schematic for a single motor configuration.

FIG. 16 is a schematic for a dual motor configuration.

### DETAILED DESCRIPTION OF THE PRESENT INVENTION

The present invention is directed to a total power plant 10 that will utilize a lithium ion battery pack 12, a fuel cell stack 14 utilizing hydrogen, ethanol and/or gasoline and a flex-fuel internal combustion engine 16 (ICE). The reason for using these systems in tandem is that, in the right quantity and configuration per application, it is possible to meet or exceed the gasoline ICE in the areas of environmental impact, safety, feasibility of refueling infrastructure, vehicle range, durability, performance and cost.

Typical operation will now be discussed:

A motorist will be able to charge their vehicle using electricity from the electrical grid. The battery pack 12 will be charged during this period and likewise, hydrogen and oxygen gas would be produced by the electrolysis of water on board the vehicle. Hydrogen gas produced will be stored on board the vehicle while oxygen gas may or may not. The commuter will unplug the vehicle once charged and begin their commute. During their trip, the vehicle would use energy from the battery and fuel cell until they reach their destination, or until one or both energy sources are expended to some predetermined level. In the latter instance, the ICE 16 would begin to produce power for the duration of the trip. When stopped, in periods of extremely low power consumption, or when the vehicle is no longer in operation (and not being charged via the electrical grid), the fuel cell stack 14 would then be used to charge the battery pack 12 to some predetermined state of charge (SOC) for the next trip providing hydrogen gas is still on board.

### Example 1

A compact car could employ a 5-6 kW fuel cell stack 14 and 10-12 kWh of battery pack 16. This could allow for about a 35-40 mile, gasoline free one-way trip. A likewise gasoline free trip of the same distance could be achieved after the fuel cell stack 14 is allowed to recharge the batteries for roughly 2-3 hours providing a hydrogen gas tank on board that holds around 1 kg of gas. The aforementioned example, scaled up to different size vehicles, can eliminate the need for gasoline in greater than 90% of commuters in the United States, and do so cost effectively when compared to a similarly classed gasoline ICE powered vehicle.

One other item regarding power plant operation is the use of “power profiles” that the motorist can select for certain performance characteristics. An example would be a profile that caters to long distance trips where the ICE is actually run at a very low power, high efficiency setting to extend the range of the vehicle. This would be better than the ICE simply turning on after the all electric range is expended and inefficiently handling power swings as needed. Another example might be to run all three portions of the power plant for maximum power. In the latter, hydrogen gas could even be the fuel used in the ICE as hydrogen internal combustion engines (HICE's) can produce about 1.5 times the power as their gasoline counter parts. Stored oxygen gas could likewise be used in the ICE.

The particular components of the power plant 10 will now be disclosed:

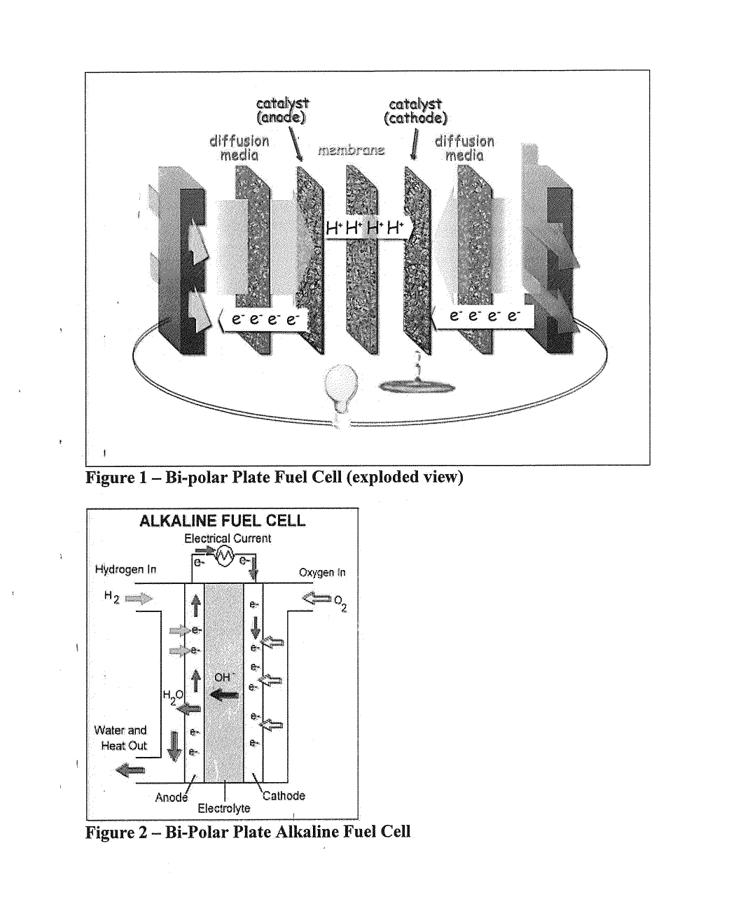

Fuel Cell Stack—It has been determined that commercially available fuel cells are adequate for the goals of the design. An example of such a fuel cell is shown in FIG. 1. The overall fuel cell stack 14 however, will consist of two types of fuel cells arranged in different quantities. The one most present is an alkaline fuel cell that uses potassium hydroxide, potassium hydroxide (aq.) or an alkaline anion exchange membrane (AAEM) as the separator as shown in FIG. 2.

These cells require the use of a pure oxygen supply or “scrubbed” atmospheric oxygen that is free of carbon dioxide. Carbon dioxide “poisons” the cell by reacting with the potassium hydroxide and forming potassium carbonate, thus rendering it useless. Another type of cell used in this design is a PEM (proton exchange membrane) cell utilizing hydrogen, ethanol and/or gasoline where the separator membrane is perfluorosulfonic acid (PFSA).

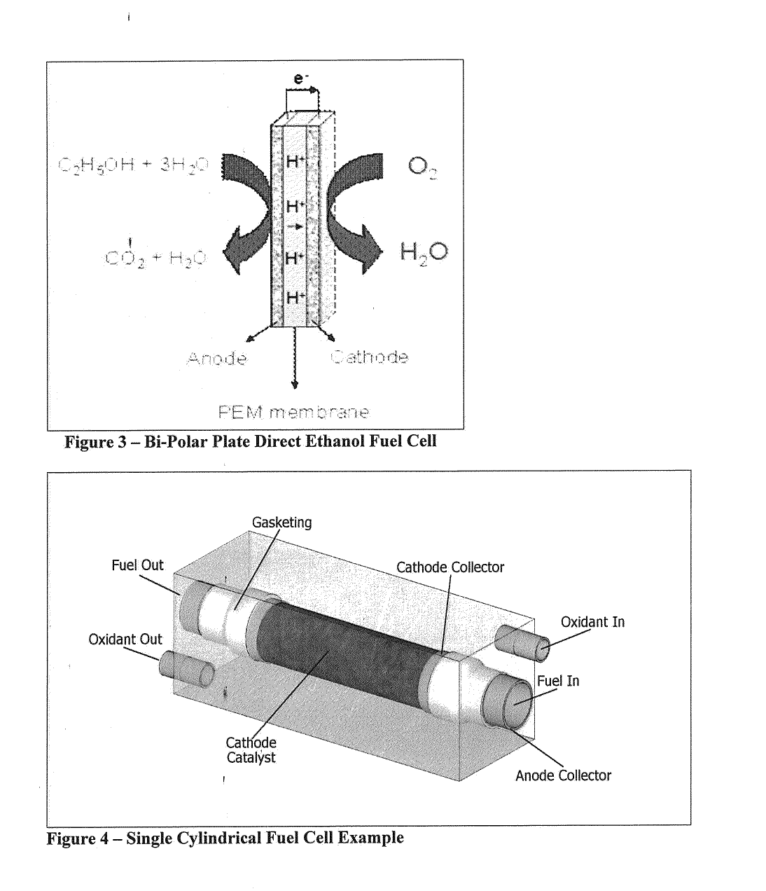

A direct ethanol fuel cell (DEFC) configuration may be used in the power plant when no more hydrogen gas is available. It may be used for recharging or at any time when the use of the flex-fuel internal combustion engine is required. Typical DEFC chemistry is shown in FIG. 3. The drawback with this cell is that many higher end catalysts, particularly platinum group metals (PGM), are “poisoned” by intermediates in the cell reaction, notably carbon monoxide. In DEFC chemistry, PFSA is again a standard ionomer.

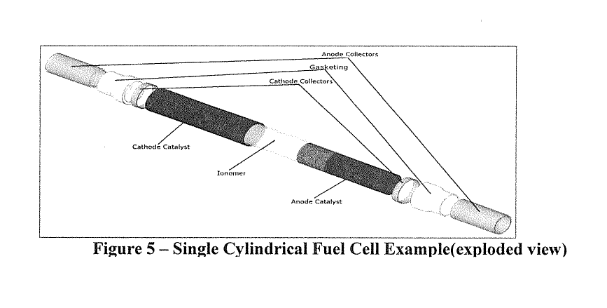

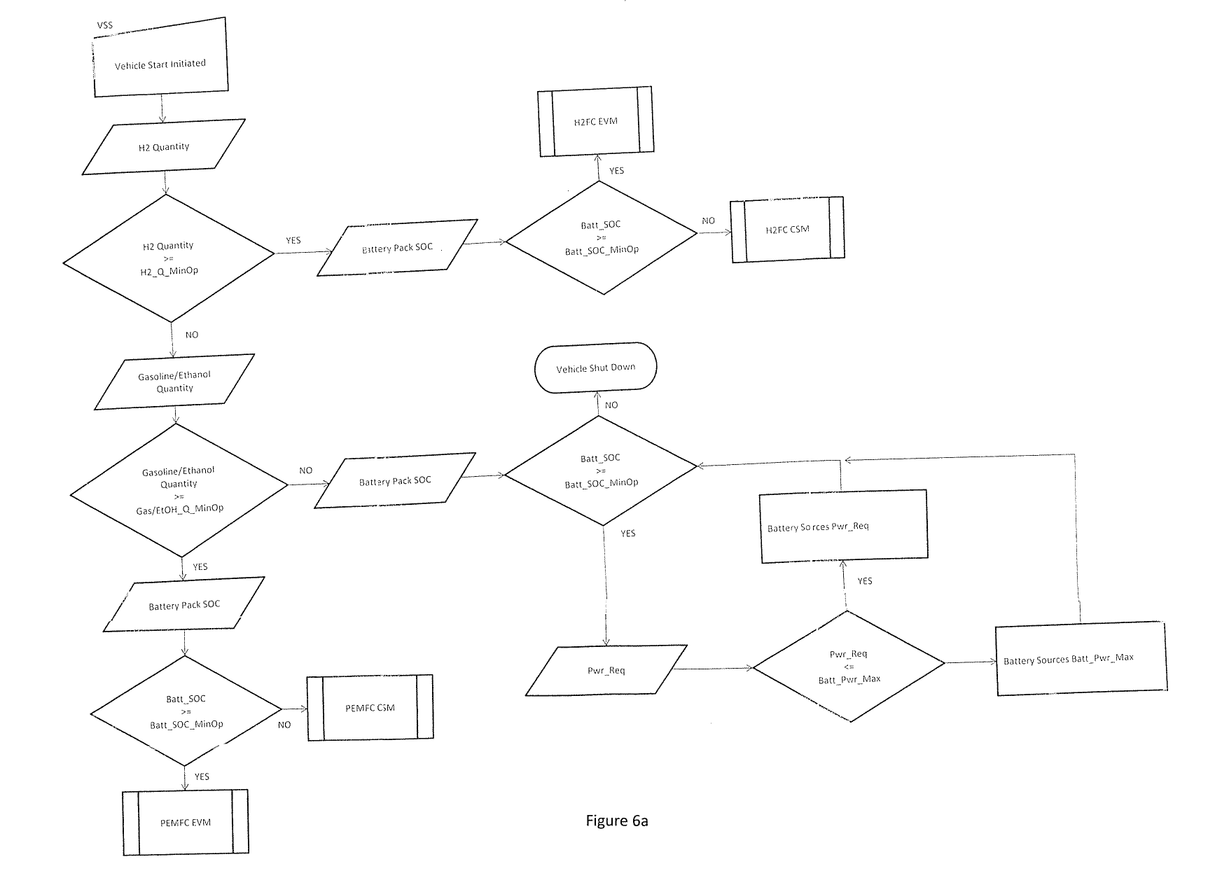

The present invention is contemplated to have a Cylindrical Fuel Cell—This fuel cell design is more cost effective than standard bi-polar plate design. The former negates the need to use bi-polar plates, decreases the amount of materials needed per unit power density, increases the MEA area used in the flow field and lessens the membrane area lost to gasketing/separating. FIGS. 4 and 5 illustrate a singular cell.

Fuel passes through the cylinder where it reacts on an inner catalyst, the separator membrane and outer catalyst, where it then reacts with the oxidant present in the surrounding chamber. As the catalyst layers are electrically conductive, the inner catalyst conducts to the anode collector that simultaneously exists as the piping to feed the fuel into the cell. This is similar to how in a bi-polar architecture; the plates conduct and provide direction for the flow field. The outer catalyst conducts to the cathode collectors and then current is fed out of the oxidant chamber, via the “oxidant in” piping or some other means. The latter connections are not shown.

FIG. 5 shows how the layers overlap. Note here that the separator membrane (referred to as an ionomer) does not have to gasket itself around the large perimeter of a bi-polar plate, but only has to cover the smaller area present around the anode collectors. Additionally, the lack of plates means no lost MEA area to flow field channels. It is very important to note that interchanging the anode and cathode flow fields is possible.

Cylindrical fuel cell operation has been confirmed via experimentation. Hydrogen gas was passed through the inner flow field to react through the MEA with atmospheric oxygen at the outer flow field. Both anode and cathode catalysts are platinum mounted on carbon gaseous diffusion layer (GDL) substrates.

### Cell Organization:

Modules and Bundles: In the present invention, individual cells are grouped in series and/or parallel and then those organizations are contained in modules (bipolar configuration) or bundles (cylindrical configuration) that are themselves in series and/or parallel combinations. The purpose of modules/bundles is to isolate failure to the singular modules/bundles, and sometimes to organize the peripheral systems more effectively (i.e. use master/slave management electronics where each slave is responsible for a module/bundle).

### Ionomers

Alkaline Fuel Cell (AFC) 18: The most favorable choice for the alkaline fuel cell is aqueous potassium hydroxide (KOH). Using this electrolyte means dealing with the absorption of atmospheric carbon dioxide which will yield a potassium carbonate (K₂CO₃) precipitate. This issue will be addressed in the Balance of Plant (BOP) section.

Proton Exchange Membrane Fuel Cell (PEMFC) 20: PFSA will most likely be used as the ionomer here, probably in the form of Nafion® or GORE-SELECT® Membranes. Note that PFSA will be used in PEM cells as follows: 1) where the fuel and oxidant are H₂ and stored or atmospheric O₂ respectively 2) where the fuel is ethanol (and possibly gasoline) and the oxidant is again stored or atmospheric O₂.

Fuel Cell Catalysts Any singular element or chemical (if that chemical is available) used as a catalyst will probably be nanoform Quantum Sphere Incorporated (QSI) materials.

AFC 22: Anode—Will consist of any combination of metals in Group VIIIB, Hypermec™ (produced by Acta) or Primea™ (produced by Gore).
Cathode—Will consist of any combination of PGM's, metals in Group IB, Hypermec™, Primea™, and metal oxides, the latter most likely MnOₓ and NiOₓ.

PEMFC 24: Anode—Same as AFC above, but might exclude PGM's if ethanol or gasoline is the fuel. Metal oxides can be used if ethanol is the fuel.
Cathode—Same as AFC, but will likewise exclude PGM's if ethanol is the fuel to avoid poisoning.
   Fuel Cell Substrates 26 Substrates will be a porous carbon-silk or carbon-paper. A metal mesh however (probably nickel) can be used on the cathode side of the AFC (studies have shown that in AFC's, carbon substrates are prone to bond to intermediates in reactions where the electrolyte absorbs CO₂)
   Fuel Cell Gaseous Diffusion Media 28 This media is generally a hydrophobic material, usually polytetrafluoroethylene (PTFE, Teflon™)

### Balance of Plant (BOP)

H₂/O₂Storage: Metal hydride canisters 30 (H₂ only)—These generally store hydrogen in the form of a metal hydride, usually in alloys of Mn, Re, Ti, Ni, Al and Cr.

Compressed gas tanks (H₂ and O₂) 32—Type IV tank made of a carbon fiber with an inner liner made of a polymer thermoplastic. This type of tank ranges from type 1 to 4 based on ANSI (American National Standards Institute) or ISO (International Standards Organization) standards for CNG (Compressed Natural Gas) tanks.

Pressure Release Valves 34—Storage methods always face varying pressure and temperature conditions when releasing and absorbing gases. As a safety feature, a release valve might be necessary. Monitoring temperature of the tank is a safety feature to be employed.

### Alkaline Electrolyte Management:

By circulating the KOH (aq.) throughout the fuel cell stack, the KOH remains more diffuse, which helps foster reaction rate and lessens ohmic losses. Excess water tends to sometimes build in the electrolyte, so to combat this phenomenon, water is removed by an evaporator (probably a rotary evaporator) and usually fed back into the flow fields or stored on board. Electrolyte flow will most likely be by means of a gear pump or rotary vane pump. An additional benefit is that the electrolyte can provide stack cooling. It will be flown into a heat exchanger both to preheat incoming reactant gases and be cooled. Electrolyte will flow through cells in series, parallel or in a combination of the two. A useful note is that parasitic currents usually exist in the electrolyte whereby they connect electrically adjacent cells in the electrolyte flow path (these currents of course, do no useful work). For this reason, the series configuration is usually preferred for the higher ohmic resistance of the electrolyte path. Likewise, non-conductive, or segments of non-conductive piping will be used in the electrolyte loop. Non-conductive mesh might also be set up in the electrolyte loop to further provide electrical resistance if necessary.

Nitrogen Purging—Many AFC designs neutralized cells when they were not in use by both draining the electrolyte into a holding tank and then flooding the cells with N₂ gas. The reason for this is mainly due to the absorption of CO₂ and the possible flooding of electrodes.

CO₂ and the Electrolyte—The AFC stack might run on atmospheric oxygen meaning it will gradually absorb some CO₂ and form a potassium carbonate (K₂CO₃) precipitate. The electrolyte might thus have to be changed out from time to time in a manner analogous to an oil change. This effect will be mitigated by simply using only the O₂ from electrolysis, or a combination of the O₂ from electrolysis and atmospheric O₂. Additionally, a CO₂ “scrubber” might be upstream of the AFC cathode flow path. It will exist in the form of a soda lime tower through which atmospheric air will be circulated prior to hitting the AFC thus removing CO₂.

### H₂O Management:

Managing moisture in fuel cells is highly important. If the electrolyte becomes too dry, it loses its ability to conduct ions. If it becomes too wet, it has a tendency to flood electrodes and prevent mass transfer. In an AFC configuration, water is produced at the anode and consumed at the cathode and in a PEMFC, it is produced at the cathode and consumed at the anode.

Humidity Sensing—Sensors/probes will be placed in cell flow fields or the general flow paths. Ambient humidity may be monitored as well.

Combining Fuel Cell Type Flow Fields—Normal individual fuel cell type moisture characteristics are generally troublesome, but as we're using the two varieties of cells in this design, it can be an advantage. A possible configuration thus, is to flow H₂ from the AFC anode into the PEMFC anode and flow O₂ from the PEMFC cathode into the AFC cathode. This series alignment of the mentioned flow paths means that lots of water is simply being circulated between the stacks instead of having to remove excess water out of the cathode flow field (PEMFC) or anode flow field (AFC) if the systems were isolated.

Counter Flow—Flowing oxidant and fuel in opposite directions within a singular cell has the effect of somewhat equalizing moisture content on both sides of the membrane. This is due to concentration gradients.

Water Condenser/Water Sumps—Water can be condensed out of the system into a sump where it can be relocated. This will need to take place at the end of the AFC anode flow field and at the end of the PEMFC cathode flow field. The sumps will see some of the produced water pumped out and relocated to the AFC cathode or the PEMFC anode. Additionally, water will be pumped to a holding tank until it is recalled for electrolysis. Introducing Water Back to Flow Fields—Water will be produced by the KOH (aq.) evaporator, the AFC anode sump and the PEMFC cathode sump. Two methods will most likely be used to humidify flow fields: 1) “Sparging”—This is when gas is bubbled through water that is temperature controlled. Since the dew point of the air is the same as the temperature of the water it is moving through 2) direct injection—This simple method shoots pressurized water into the flow field in a fine mist by means of an ejector circulator (discussed in Flow Field Management). Sometimes, metal foam over the injection tube is used to develop a finer spray of water droplets. The water here might also be pre-heated if necessary.

Direct Ethanol Fuel Cell Considerations—Water in this configuration (PEM cells only), is produced at the cathode. It might thus be removed and reinserted back to the anode, or at the beginning of the cathode flow path. Water will also be pumped into the flow path of the anode as it is a necessary part of the anode reaction.

### Thermal Management:

The heat exchanger mentioned herein can utilize either a counter-flow, or parallel-flow configuration.

Electrolyte Cooler—In the AFC as mentioned, the primary cooling mechanism will be to cool the circulating electrolyte. This will be done by means of a heat exchanger in which either atmospheric air, reaction gases (directly from storage mechanisms before entering a flow field) or a liquid coolant is passed through the heat exchanger.

Electrolyte Evaporator—In the event that excess water needs to be removed from the electrolyte in the AFC, hot reaction gases or hot liquid coolant might be used to further heat the electrolyte.

Flow Field Cooler—At the exit of any of the cells, a heat exchanger would be used to cool left over fuel and oxidant. This is necessary to condense product water vapor. Again, atmospheric air, reaction gases (directly from storage mechanisms before entering the flow field) or liquid coolant is passed through the heat exchanger.

Flow Field Compressors—Compressors would be used to facilitate movement of reaction gases in the flow fields. They contribute significantly to thermal regulation in many cases due to the temperature differentials they create.

Bi-Polar Plate Cooling—It is a common practice to run atmospheric air, reaction gases, or liquid coolant through channels in bi-polar plates and this method may be employed.

Combining Coolant Loops—The three main components in the overall power plant require thermal management. Fuel cells often need time to build up to maximum power output. They need to build to the right temperatures, pressures and flow rates to do so. It might be effective to actually run the power plant “dirty” at start up by running the ICE for a small time period, taking advantage of its heat output. A coolant loop from the ICE or even battery pack to the fuel cell stack might be necessary. Another issue where ICE or battery pack heat might be used arises if ice or frozen electrolyte on board the vehicle needs to be liquefied.

Liquid Coolant Loops—Liquid coolants will either be cooled via a heat exchanger and atmospheric air or reaction gases.

Temperature Sensors—Temperature sensors, such as thermocouples will be used throughout the fuel cell stack. They may be on each individual cell, cell bundles and/or cell modules.

### Flow Path Management:

Introducing Gas to Flow Fields—A valve on the H₂/O₂ storage tanks, probably a commercially available ball or plug valve made of Inconel™ by Special Metals Corporation, will release gas into piping. The piping will again, pass that gas through any pre-heating mechanisms discussed above and will inject it into the flow field. Note that if no atmospheric gases are used, the system will essentially be closed-loop. This could be done by a singular or combination of the following mechanisms:

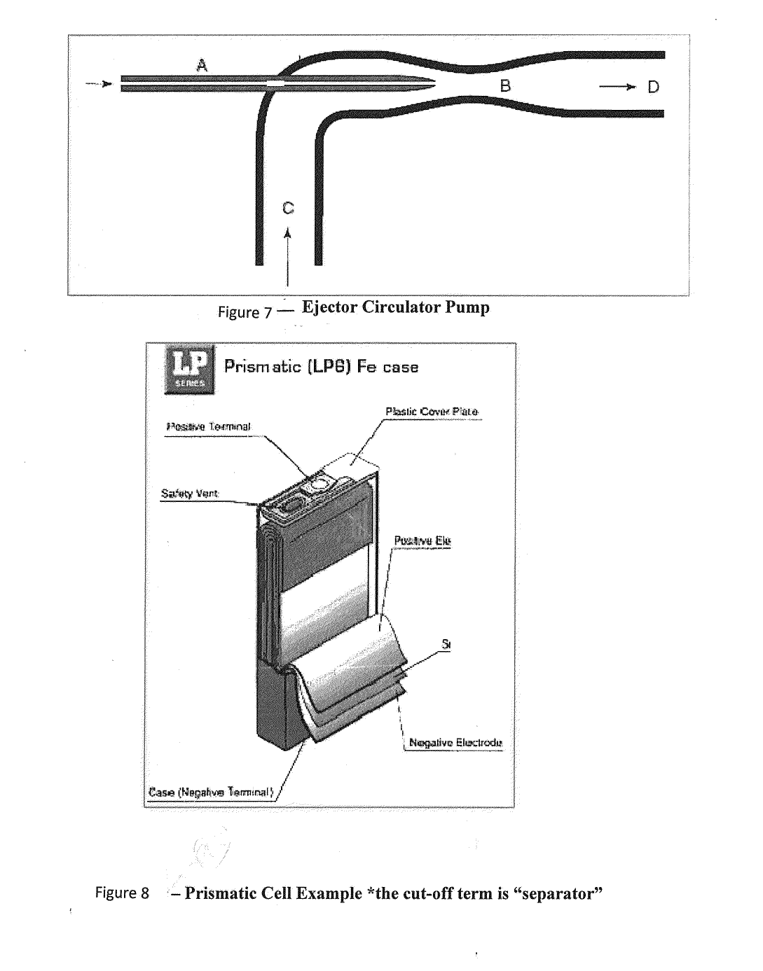

Ejector Circulator 100—This is shown in FIG. 7.

1) Ejector Circulator Pump 102—Injecting the gas through internal piping (104), where it is then passed through the venturi (106). The expanding gas then draws flow from preceding piping (108) while moving towards the cells (110). This method is attractive because it allows for essentially “free” circulation. The energy that provides flow is taken from the high pressure storage in the gas storage tanks. It is also possible that water vapor could be introduced into the flow fields this way.

2) Pumps 112—Eventually the pressure in the gas storage tanks will no longer be able to facilitate ejector circulator operation. Pumps will be necessary to provide the pressure differential. The pumps can be either Lyshom®/screw pump, Roots® pump or centrifugal/radial variety. The pumps will be needed to compress product gases from electrolysis.

Pressure Sensors 114—These will be utilized at various points in the flow path for both safety, and optimizing operation during use.

Electrolysis—Upon recharging of the vehicle, stored H₂O will be moved into the mechanisms for electrolysis. This will happen in one of two ways: 1) H₂O will be pumped into the fuel cells or 2) Separate electrolysis cells will be used. It is contemplated that either or both methods could be used. The product gases will then be pumped into storage vessels. They will be likewise compressed if stored in gas tanks.

Atmospheric Oxygen—When O₂ from the atmosphere is used, it will be simply run through the cell and then vented back into the atmosphere. It will be pushed through the flow path via a fan or blower. For use in the AFC, it must be run through a CO₂ scrubber. The latter is not the case in the PEM cells.

Direct Ethanol Fuel Cell Considerations—In this configuration, ethanol and or gasoline will directly flow through the anode flow path of the PEM cells. Product CO₂ will be vented to the atmosphere. The DEFC configuration will simply have both anode and cathode flow paths separated from the AFC: The anode possesses carbon (mostly in the form of product CO₂) from the ethanol that would harm the AFC and the cathode possesses product CO₂ from fuel that “crosses over” from the anode and possibly CO₂ from the atmosphere. Both flow path loops will thus need to be vented to the atmosphere. Fuel flow is contemplated to be by gear pump or rotary vane pump if liquid, or any means used in the AFC if gaseous, while oxidant flow will be by any methods used in the AFC.

### Battery Pack 12

Lithium Batteries—Lithium ion or lithium polymer ion batteries will be used in this design. Lithium iron nano-phosphate batteries such as those made by the company A123 are contemplated to be used.

Materials Moving from anode to cathode: an individual lithium battery cell will consist of an anode current collector with the anode material/binder slurry pressed and normally baked onto it. Usually, a solid electrolyte interface is present within the anode electrode material. Sandwiched onto the latter is a separator. Sandwiched onto the separator is the cathode material/binder slurry similarly pressed and normally cooked onto a cathode current collector. The cathode materials contain an electrolyte to foster charge transfer. This electrolyte might be liquid, but will probably be a solid polymer.

### Electrodes:

Anode—The contemplated materials to be used are carbon in the form of graphite or coke, lithium titanate oxides and silicon.

Solid Electrolyte Interface—This layer is formed during manufacturing of the battery. When a potential difference is applied initially to the cell (first charge cycle), the electrolyte reacts with carbon anode materials and produces an electrically resistive layer which prevents self discharge. The layer increases with additional use of the cells, but controlling its initial formation is an important part of cell design.

Cathode—Possible materials to be used here are lithium cobalt oxide (LiCoO₂), lithium manganese oxide (LiMnzO₄), lithium nickel cobalt manganese oxide ((Li(NiCoMn)O₂) (also called lithium NCM)), lithium nickel cobalt aluminum oxide (Li(NiCoAl)O₂) (also called lithium NCA)), lithium iron phosphate (LiFePO₄) and lithium sulfur (Li₂S₈).

Anode/Cathode Current Collectors—These are contemplated to be Cu for the anode and Al for the cathode. These collectors are normally corrugated or porous on the side adjacent to the inside of the cell to maximize reaction rate.

Binders—A conductive binding material in a solvent is initially mixed with the electrode materials to form a slurry. When the electrode materials are baked onto the current collector foils, the solvent is evaporated. The binder's purpose is to provide a conductive porous region for ions to travel, via the electrolyte, through the electrode and also adhere the electrode material to adjacent parts of the cell.

### Separator:

The separator is an electrically nonconductive layer that prevents a short between anode and cathode but allows lithium ion transfer. This layer can be fabricated from either micro-porous polypropylene, polyethylene, nylon or fiberglass.

### Electrolyte:

This is the medium through which Li ions travel in the electrodes.

Liquid Electrolyte—The liquid electrolyte is contemplated to be lithium hexafluorophosphate (LiPF₆), or some other equivalent lithium salt.

Polymer Electrolyte—A polymer electrolyte can also be used. Polymer electrolytes provide better stability and are not prone to the possibility of leaking like the liquid electrolytes. Generally, it is a polymer composite like polyethylene oxide or polyacrylonitrile.

### Doping:

There are a wide variety of substances used in electrolytes, binders, electrode materials and even in the separator and this is done to improve things like thermal stability, improve ion flow, curb malevolent intermediate reactions, catalyze necessary intermediate reactions and suppress dendrite growth.

### Cell Organization:

Individual cells are stacked either in a monopolar or bipolar manner. Note the reason for monopolar stacks is that the current collector plays an important role in battery cell chemistry. It is for this reason that using a bipolar arrangement in batteries (where the current collectors are of the same material) tends to be somewhat detrimental, usually in the form of higher self discharge rates. Cells will be organized at the cell and module levels as in the fuel cell stack.

### Casing Configuration:

For traction (mobile) battery applications, three main casing arrangements are favored having trade-offs with respect to energy density, mechanical strength, thermal management and material costs.

Prismatic—In this design, The cell is encased in a rectangular container as is, or in a cylindrical roll (also called a “jelly roll”), bend or weave as shown in FIG. 8.

Cylindrical Can—Here, the cell is wound in a jelly roll and encased into a can.

Pouch—The stack is contained in a foil pouch in a jelly roll, bend or weave.

### Battery Management System (BMS):

The purpose of the battery management system is to provide battery protection/management by monitoring temperature, discharge/charge current, discharge/charge voltage, state of charge (SOC) and state of health (SOH). The subsystems of a BMS are closely related to and reliant on one another where lithium chemistries are used. The latter is due to the strict operating parameters of such chemistries.

### SOH:

Generally, a lithium traction battery's life is measured in its usable capacity. When that capacity drops to about 80% of what it was immediately after being manufactured, it is considered to be at the end of its life. Thus, if the usable capacity of a pack is say 10 kWh, a charging mechanism cannot put that full 10 kWh into that pack as it ages, nor will the battery discharge that much energy. To determine what capacity the batteries can handle and other performance characteristics, a SOH system needs to identify where the battery is in its life. Its components are as follows:

Battery Pack Model—Extensive testing is done on pack designs before they come to market. This data is logged digitally, and is available on board a vehicle for reference to determine what operating parameters are.

Algorithms and Decision Logic—In tandem with the battery model is usually sets of algorithms and decision logic that determine operating parameters as well as direct cell operation.

Battery Log Book—Use of the battery is logged. Things like cycle count, lifetime energy input and output, discharge/charge rates, temperature data and abuse (i.e.: operating outside voltage/current/temperatures etc.) are taken into account and referenced by the algorithms and decision logic.

Impedance/Conductance Testing—In tandem with referencing the log book, this is the most effective way to see where in its life a battery pack is. An external potential difference is put across individual cells, and the resistance value of those cells is roughly proportional to battery capacity and performance.

### SOC:

Particularly with traction batteries, SOC determination is extremely important. It is essentially the “gas gauge” in an EV, or the available remaining energy capacity for use. The SOC system works with the SOH system. Simply monitoring one characteristic of the cells will not yield precise enough measurements for SOC determination. The following are data points that need to be sampled, run through an A/D converter, logged and delivered to software. Naturally, it is this data combined with digital systems that ultimately gives a precise SOC indication.

Cell Voltage—Lithium batteries have a very shallow discharge curve (voltage is relatively constant at most SOC's), so simply monitoring cell voltage is not an effective means by which to determine SOC, like with other chemistries. It is useful as a check however, and it is essential to monitor for successful operation. Voltage will be monitored on each individual cell, or groups of cells in parallel. The latter will be done with an individual voltmeter per each individual cell, or through a voltmeter that multiplexes the voltage over a group of cells.

Coulomb Counting—This method integrates the charge that goes into and out of a cell with respect to time. It can be done by a simple integrator circuit with a shunt resistor, a Hall Effect sensor or a magneto resistance sensor, or any combination of the three. It is also worth noting that the design will not just monitor current for the sake of counting charge in coulombs. With varying charge and discharge rates (varying amperage), efficiency fluctuates. Thus, amperage must be likewise included as SOC determining data. Like voltage, every individual cell will have its amperage monitored either individually or via a multiplexor.

Temperature—Cell temperatures must be sampled as well. Temperature has a direct impact on efficiency and so it must be factored into the data. An ambient temperature sensor is contemplated as well.

### Cell Protection:

Lithium cells are very vulnerable to many potential problems such as overvoltage, high charge or discharge rates, operation outside of strict temperature parameters, “gassing” (and thus high pressure) and to mechanical stress. These threats unfortunately are all related and usually cause the others to happen. Protecting cells and keeping them within their defined window of operation is essential.

Electrical—The best means to provide protection from overvoltage and current is via transistors. If an interrupt signal is sent from decision logic chips, a transistor will be triggered many times faster than a mechanical relay or a fuse, and do so in time to prevent damage. Transistors simply have their source/drain (for field effect transistors (FET's)) or collector/emitter (for bipolar transistors) junctions in the current path of the individual cells or modules. Most traction batteries use insulated gate bipolar transistors (IGBT's).

Thermal Sensing—Thermal sensors must detect when the pack is out of operating parameters. This applies during charging as well as discharging. This could be accomplished by positive temperature coefficient (PTC) or negative temperature coefficient (NTC) thermistors. In the latter two cases, it's possible that these might be employed as temperature monitoring devices as well as protection devices. Thermal monitoring may be on each individual cell or one will be allotted for a group of cells.

Thermal Management—When thermal monitoring shows temperatures that are out of operating parameters, electrical cut-off will take place. Note too that lithium batteries cannot function at lower temperatures as well. This means they may need to be heated before operation. The battery pack will be liquid cooled and liquid or electrically heated. Cooling/heating loops for each of the main sections of the power plant may be interconnected, conditionally interconnected or isolated completely. Digital systems will take into account all cell data and SOH information to determine proper operation.

Separator “fuse”—Some separators are actually designed to melt when they reach temperatures significantly beyond operating parameters. This prevents anymore ion transfer and the battery shuts down. That cell and probably its module is thus destroyed, but the other modules survive.

Venting Seals—In extreme cases, operating beyond acceptable parameters will cause thermal runaway. In lithium chemistries, the electrolyte may then “gas”. This is where flammable gasses are released from the electrolyte and could cause the battery to fail. Pressure release valves or seals are thus mandatory in this worst case scenario.

Mechanical Swelling—It's worth noting that enough room in the cell encasement must be left for “swelling”. When ions move from anode to cathode or cathode to anode, the receiving electrode physically enlarges and the donating electrode physically compresses.

Battery Modules—In the event of module failure, it will still be possible for other modules to supply power for the vehicle by bypassing the failed cells electrically. This allows the vehicle to continue to operate until it is repaired, but obviously at much lower power and capacity.

### Drive Train 200:

This portion of the design is to be broken into two parts. First, power coupling/decoupling of the different individual power plants onto the DC power bus (also commonly referred to as the DC link) is disclosed. Second, from the DC power bus to the wheels is disclosed. It should be noted that electric drive trains are generally divided into “series”, “parallel” and “mixed”. This refers to how the propulsion power is coupled; series referring to electrically and parallel referring to mechanically. The present invention will only be electrically coupled.

Individual Power Plants to/from DC Bus

### Basic Series Hybrid Electric Drive Train:

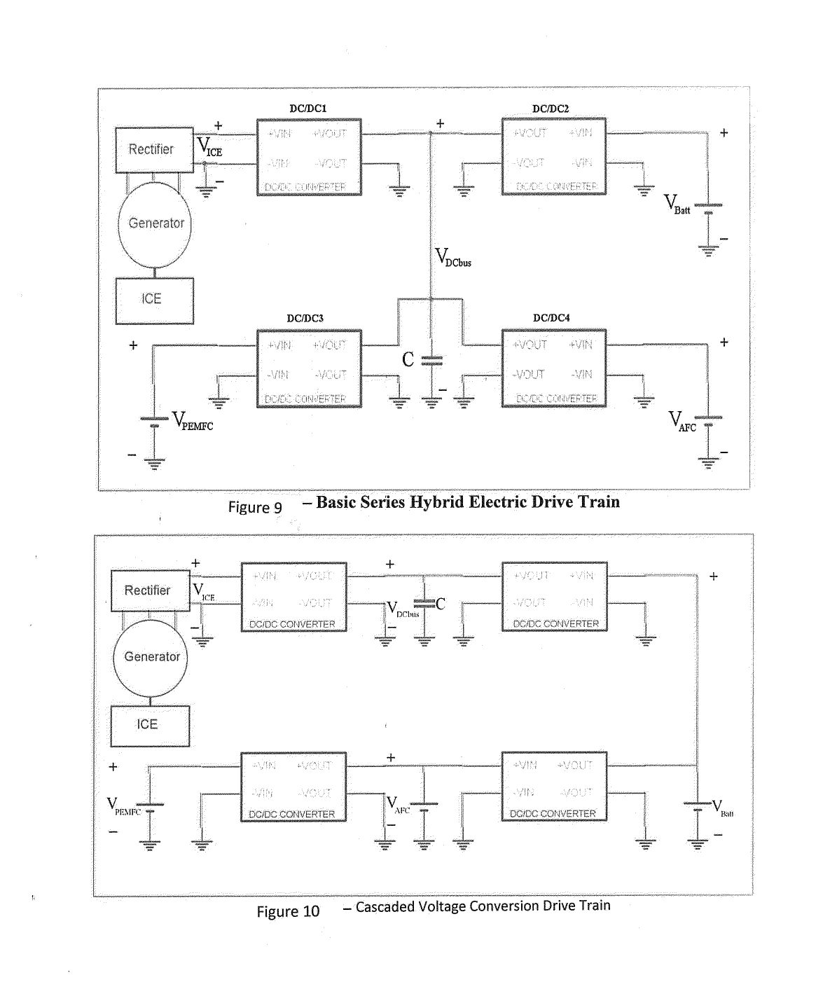

In FIG. 9, a basic configuration is shown. The premise is that all individual power plants are separated electrically before contacting the DC bus 202. To couple/decouple their powers, DC/DC 204 converters are necessary to boost the voltages to the level of the DC bus, or buck the DC bus voltage to the levels of the individual power plants during regenerative braking. The DC bus is kept at a voltage necessary to supply all power needs of the electric motor/motors 206 and thus, controlling motor power is synonymous with controlling discharge current. It is possible that no DC/DC converters are needed as it might be possible to design them to operate at the necessary DC bus voltage (though highly unlikely for the fuel cells). A capacitor (C) is shown here to handle large fluctuations in DC bus voltage when needed. In FIG. 9 and FIG. 10, regenerated braking power can be taken off the DC bus from all individual power plants other than the generator. For the battery pack this is obvious, but as mentioned before, fuel cells have a large amount of capacitance and can handle large voltage swings. They can thus be used to temporarily store regenerated energy. Additionally, regenerative braking energy will cause the electrolysis of water to take place in the alkaline fuel cells' electrolyte.

### Cascaded Voltage Conversion:

This design is similar to that of FIG. 9, but uses DC/DC converters to buck or boost the voltages of the PEMFC, AFC and battery pack in succession. The goal is to reduce the amount of power electronics illustrated by the design in FIG. 9.

### Standard Series Drive Train:

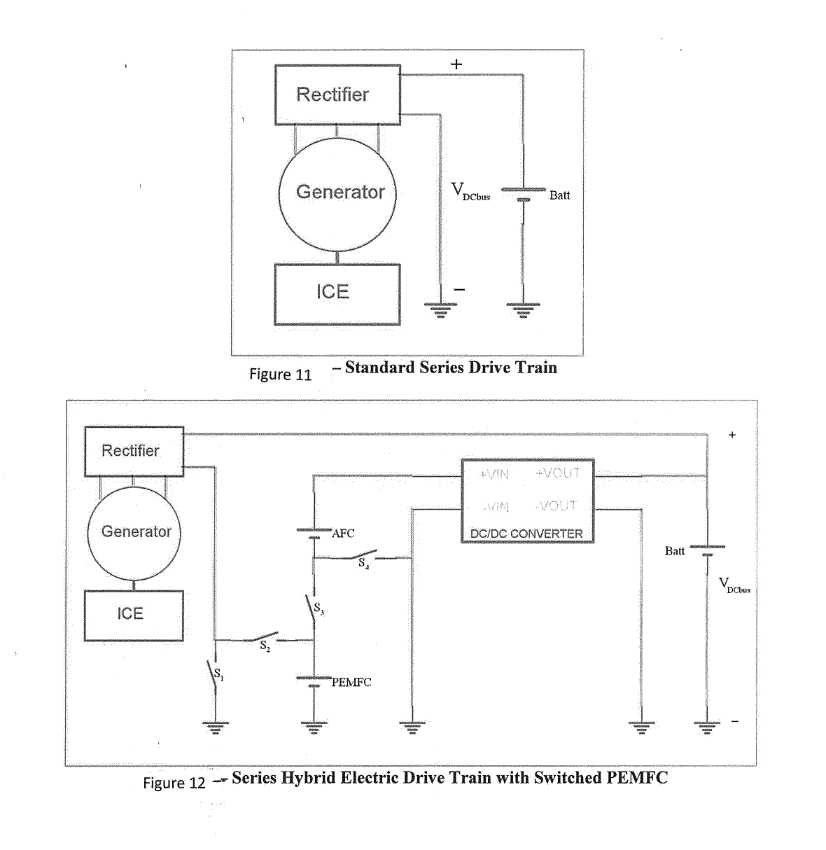

FIG. 11 illustrates the operation of currently available series drive trains. More likely than not, no DC/DC conversion of the rectified generator voltage will be needed as it can be controlled adequately with throttling and by altering the generator's magnetic fields. The battery pack is probably going to be large enough to safely be designed to operate at bus voltage in the invention. If the above is true in a standard series arrangement, the generator supplies minimal power until the battery pack reaches a specified SOC, or it turns on only when the battery reaches a specified SOC, and that SOC is then sustained. The following aspect of the present invention modifies the available design in FIG. 11 by factoring in the fuel cell stacks.

The main design challenge in incorporating the fuel cell stacks into the standard series configuration is that the PEMFCs and AFCs must operate separately when the vehicle depletes the available H₂. In FIGS. 9 and 10, this is not a problem as all individual power plants are separated electrically from the DC bus.

Another issue is that the power plant ideally should be able to operate in all of the following modes:

EV (all electric vehicle mode)—The ICE/generator is not used, unless a very high power setting is required.

CD (charge depletion mode)—The ICE/generator operates in its maximum efficiency region so as not to operate outside the latter when the battery pack and fuel cells can no longer source power.

CS (charge sustain mode)—The battery pack is at the lowest operable SOC and all other available power plants sustain that SOC.

SC (stationary charge mode)—The vehicle is not being operated and the fuel cells are charging the battery pack.

The following arguments of the present invention are directed to solving these issues with fuel cell stack integration.
Series Hybrid Electric Drive Train with Switched PEMFC:

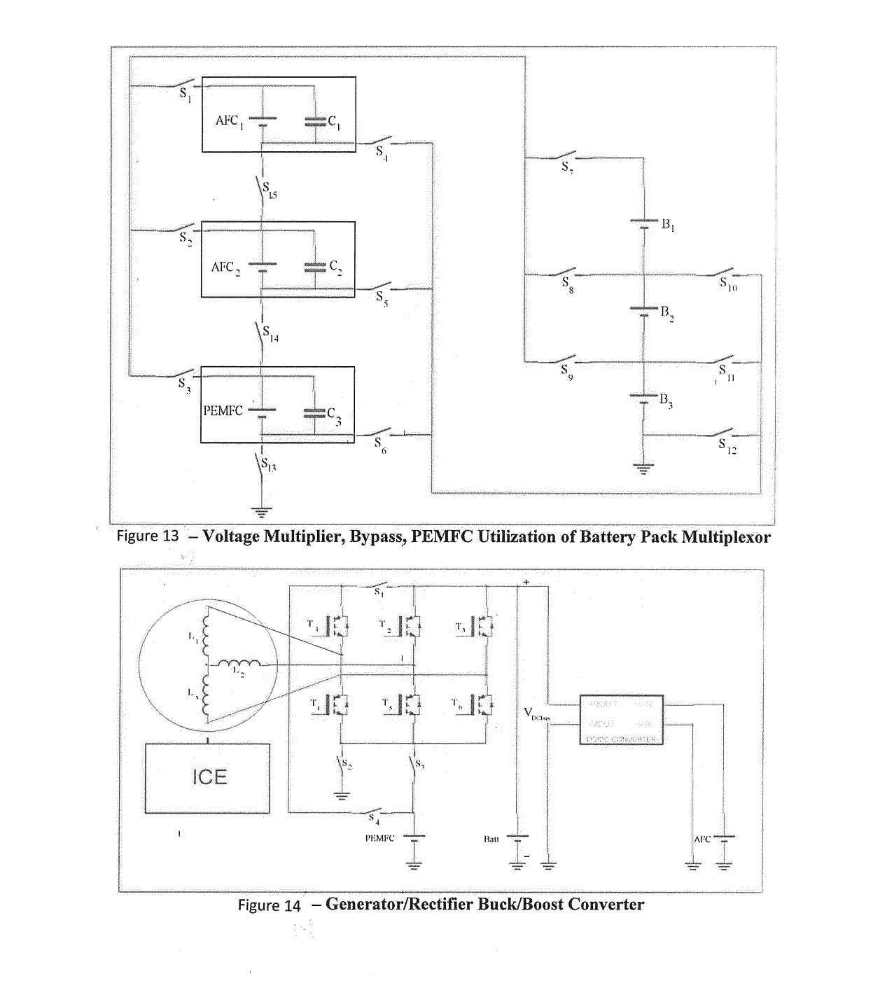

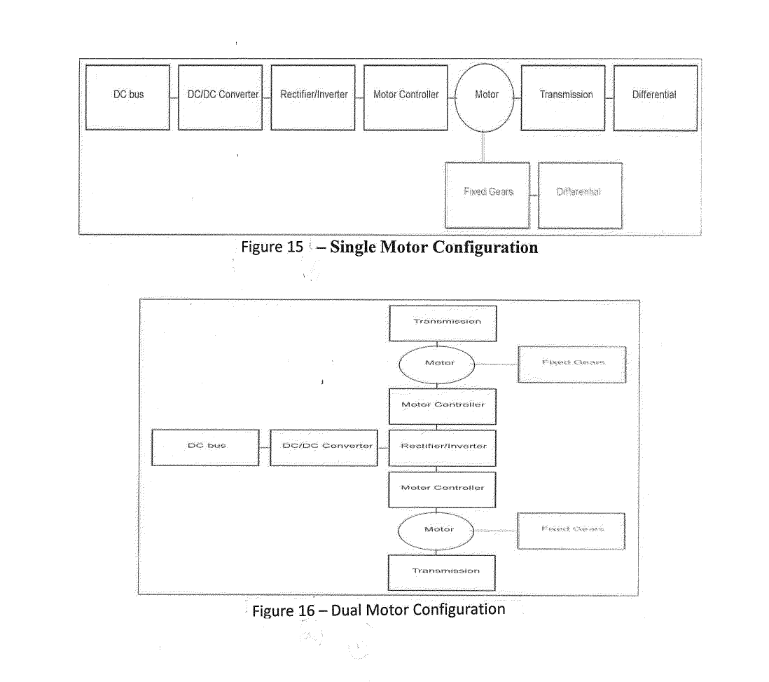

In this configuration, the vehicle initially, assuming an operable battery pack SOC and that H₂ is available, has switches 1 and 3 in the closed position. When available H₂ is depleted, and providing there is available EtOH for the PEMFC, switches 1 and 3 are opened and 2 and 4 are closed. Now the PEMFC runs on EtOH and is in series with the rectified generator power. It is no longer directly connected electrically to the AFC. The AFC is now connected to ground and can use its capacitance and water electrolysis to capture regenerated braking power. Note that if no EtOH is available if the PEMFC does not operate on gasoline when the H₂ is depleted, the initial switches 1 and 3 simply remain closed and 2 and 4 are open so that the ICE is the only thing powering the vehicle. Now the only mode in this configuration to discuss is SC mode when all H₂ has been depleted, and it must solely be done by the PEMFC using EtOH and or gasoline. There are three possibilities for this: a PEMFC bypass to the total fuel cell stack DC/DC converter, a voltage multiplier circuit using AFC capacitance and charging the battery pack via the battery pack multiplexor. All configurations are shown via FIG. 13.

### Voltage Multiplier:

In FIG. 13, the total fuel cell stack and battery pack, is illustrated with three cells in series. The fuel cells are blocked in a black rectangle with their inherent capacitance so that no actual external capacitor is present to them. So again, in SC mode, the PEMFC provides power from EtOH and or gasoline. This is a standard voltage multiplier. Assume initially that all switches are in the open position. Then, switches 2, 3, 5 and 6 close. The voltage on AFC₂ rises to that of the PEMFC and holds that voltage when switches 2 and 5 open. Immediately after, switches 1 and 4 close and AFC₁ is brought up to the voltage of the PEMFC. Now, switches 1, 4, 3 and 6 open and switches 13, 14 and 15 are closed. The voltage of the stack has now been tripled (or multiplied as many times as this process would occur). Note that the cathode of AFC, connects to +Vin of the DC/DC converter in FIG. 12, and that of B₁ connects to +Vout of the same DC/DC converter. So now that the total fuel cell stack is in series, its power is delivered to the DC bus in FIG. 12 and the batteries receive some charge. The process obviously repeats until the battery pack is at its full SOC.

### PEMFC Bypass:

This configuration assumes that the DC/DC converter can boost the PEMFC's voltage to that of the battery pack. Switchs 13 and 3 are closed and this connection would go directly to the +Vin node. The rest of the fuel cell stack would then have to be switched off of the +Vin node (not shown).

### PEMFC Utilization of Battery Pack Multiplexor:

The cells in the battery pack might be attached to a multiplexor for reasons discussed in the battery charging section and because of the requirements of the SOH and SOC systems. In FIG. 13, switches 3 and 6 would close and deliver PEMFC charge to specific battery cells. It's important to realize here that only one battery cell can be charged at a time if this method is used. The set up is better used by discharging individual battery cells to cells in the fuel cell stack as is disclosed in the charging section.

Concerning the previous three SC mode mechanisms: they might eliminate the need for the PEMFC to be switched into series with the rectified generator voltage in EV, CD and CS mode, but the latter is still attractive because it's always more efficient to deliver power directly to the load rather than to have that energy change forms multiple times.

### Generator/Rectifier Buck/Boost Converter:

This last configuration splits the PEMFC and AFC electrically. The AFC is again boosted to the battery pack voltage which is again the DC bus. Both the battery pack and AFC operate normally. The transistor array (less switch 1 which would normally be shorted, and is therefore always closed during generator operation) is a typical pulse width modulation (PWM) controlled, 3-phase rectifier/inverter circuit. It is connected to the generator's windings denoted as L₁, L₂ and L₃, which are arranged in a wye formation. So during operation in CS and CD modes, switches 2 and 4 are open and switches 1 and 3 are closed. This puts the PEMFC and rectified generator sources in series. Switch 2 is almost always open unless there is a situation that calls for stand-alone generator operation ie: no EtOH, gasoline or H₂ available for the PEMFC. In EV and SC mode, the generator and rectifier/inverter becomes a buck/boost converter. This is done by having switches 1, 2 and 3 open while switch 4 closes. Initially, the motor might move and turn the engine, so it might have to be disengaged. The rotor will not move once settled as we're effectively only repeating the poles it just saw over and over again. There are other configurations for this circuitry based on the type of generator being used, but the basic premise is that the PEMFC is using the inductance of the generator in a buck/boost circuit and that the generator is not converting mechanical energy from the ICE.

### Specific Components:

Switches—Switches may be transistors, probably IGBT's or mechanical relays. Series or parallel arrays of both of the latter are possible.

Capacitors—These will be electrolytic, polymer or supercapacitors. Series and parallel combinations of these are also possible.

DC/DC Buck/Boost Converters—There are many available designs, but in all cases they should be able to be bidirectional. Series and parallel combinations of these are also possible.

Generator—This will be either a multi-phase permanent magnet brushless DC generator, induction generator or a switched reluctance generator. They may incorporate variable torque technologies. Variable torque motors are generally used in trucking, but might find application here.

DC Bus to/from Wheels

### Single Motor Configuration:

Moving out from the DC bus, a bidirectional DC/DC buck/boost converter may be needed particularly if the batteries or fuel cells are designed to be naturally at bus voltage. The motor may produce braking energy at a voltage significantly above bus voltage. The rectifier/inverter changes DC power into AC during discharge and does the opposite during regenerative braking. The motor controller simply inputs power to the motor based on driver input and driving conditions. Note that the DC/DC converter, rectifier/inverter and motor controller might actually all be one block. The typical PWM rectifier/inverter circuit from FIG. 14 is an example of such an arrangement (though it would be without switch 1). From the motor, mechanical motion will either be transferred through a transmission and then to a differential and to the wheels or, as is shown in blue to denote another possibility, fixed gears could take the place of the transmission. It's possible that no gears are even necessary as the motor being used will probably have a desirable torque/speed curve.

### Dual Motor Configuration:

This is basically the same as the single motor configuration, but could offer some advantages. Notice there is no differential needed. As above, gears may be fixed or a transmission might be used.

### Specific Components:

Motors—These, like the generator, could be permanent magnet brushless DC motors, switched reluctance motors or induction motors. They could likewise be of the variable torque variety.

Motor Controllers—These will be four quadrant controllers.

Transmissions—These will be automatic and probably be a set of compounded planetary gears. The transmission might also be a continuously variable transmission (CVT), either pulley type, toroidal type or hydrostatic type. It might also incorporate electronically controlled valves.

Differential—This will probably be a limited slip clutch type differential.

Rectifier/Inverter—Not shown, but one per wheel may be used here.

### Charging Mechanisms/Cell Balancing and Charging Methods:

Lithium battery technology is sensitive to overvoltage. Additionally, cells in the same battery pack often age differently, so halfway through the life of the pack, one cell's usable energy content might differ drastically from the cells it is in series with. Thus, simply charging the battery pack by applying the necessary charging voltage across it does not take full advantage of the possible energy content it can hold. The charger would have to stop the process when the cell with the smallest usable energy content is at max SOC, or that cell would be damaged. This of course all has a large impact on how the batteries must be charged and discharged. This section will be broken into charging mechanisms and charging methods.

### Charging Mechanisms:

No matter what the actual mechanism, cells in series will be charged initially by directly applying the necessary voltage over that series chain. To bring the rest of the cells up to their full SOC, a few methods can be employed, and this is referred to as cell balancing.

Initial Charging—The cells in a series chain will be charged initially by sourcing grid energy from either a specified charging unit that is external to the vehicle, or by a simple house hold outlet. In the former case, the charger rectifies AC grid power, boosts it to the necessary charging voltage, and sources it to the DC bus. In the latter configuration, the AC grid energy is sourced directly between the motor/motors and the motor controller/inverter/rectifier units. It is then boosted to the necessary charging voltage. Both battery pack and fuel cells are charged (again, the fuel cells are electrolytically converting water back into H₂ and O₂). When the first battery cell reaches its maximum SOC as determined by the battery management system (BMS), the charging mechanism must switch into cell balancing mode.

### Cell Balancing:

Charge Shunting—Here, the battery pack bypasses the cells with a maximum SOC with switching and a high power bypass resistor.

Capacitive Shuttle (“flying capacitor”)—This uses a switched capacitor over the cells to equalize their charges, usually taking charge from the cells with the highest SOC and redistributing them to cells with lesser SOC's. Multiple capacitors may be used to speed the process.

Inductive Shuttle—Similar to a capacitive shuttle, this mechanism uses a switched primary winding, or individual windings per each series cell to initially take charge from cells with higher SOC. A secondary winding is affixed to the primary forming a transformer. The secondary winding then redistributes the charge to cells with lesser SOC.

No Cell Balancing—A crude approach where the BMS realizes that the cell with the poorest SOH is brought to full SOC, and then the entire series chain stops taking anymore charge.

Fuel Cell Charge Shunting—Particular to this power plant, the battery pack multiplexor shown in FIG. 13 is used. When the first cell comes to a full SOC, the multiplexor discharges that cell across some of the fuel cells so that the electrical energy is converted into H₂ and O₂. Now, the series chain can continue to charge. The BMS will predict how much charge needs to be dissipated for the certain battery cell based on SOH and the battery model. As cells can usually discharge at a higher rate than they can charge, this method seems to be quick and relatively efficient.

### Discharging:

Like the cells charge at different rates based on their SOH, they also discharge in the same manner which means that there might be unused capacity when the first cell in a series chain reaches its lowest operable SOC. Any cell balancing mechanism above that redistributes power can be used to either give cells at their lowest SOC more charge. In the case of fuel cell charge shunting, the cells that still have operable SOCs can distribute their charge in parallel with some number of fuel cells via the battery pack multiplexor connection with the fuel cell stack.

Charging Cut-off—The charging mechanism obviously needs to know when to stop charging the batteries. The predominant way that this will be done is simply by monitoring all the cells' SOCs. As a safety precaution, temperature cut-off and time cut-off will be instituted as well.

### Charging Methods:

Though it is possible to just apply a charging voltage and pure DC across a set of cells to charge them, this fails to take into account things like safety and efficiency.

Battery Methods

Constant Current/Constant Voltage—This method initially applies a fixed current to the cells. At a predetermined time and or voltage, the cells are then charged at a constant voltage to ensure that the cells cannot be subject to overvoltage.

Pulse Charging: This refers to how current and voltage are sourced over the cell. By pulsing the charging signals rather than just applying a constant direct current, the cell has time to adjust and normalize polarization effects.

Reflex Charging: Also known as “Burp” or “Negative Pulse” charging, this is actually quite similar to pulse charging. The difference is that the cells receive an abrupt, high current, reverse bias potential across the cells. This more quickly depolarizes the cell and also may help in dendrite formation (crystal growths in the cell that come with age and are detrimental to cell performance).

Fuel Cell Methods—Charging constraints for the fuel cells in the electrolyzer configuration are much less stringent than for the batteries. Cells in series will simply have a charging potential difference put across them. Eventually, when cells in the stack simply have no more water to convert to H₂ and O₂, the charging power will be lessened, but will still pass current through the cells that have expended their water, or when possible, skip cells by means of the switched capacitor circuitry in FIG. 13. This is done by using the cells closest to the cathode and then rerouting current from anode of the last cell in series that still has water down to ground for the efficiency gains. One other note is that charging current can be drastically lessened and this would result in an extremely high conversion efficiency. The motorist will have the option to pick the charging time they would like for this reason.

Regenerative Braking—Most of the components necessary for regenerative braking are already present on board the vehicle. The motor or motors simply use the 4-quadrant motor controller/s and the rectifier/inverter/s to put power back on the DC bus at the correct charging voltage via the DC/DC converter. If no DC/DC converter precedes the electrical path from the motors (generators), then the DC bus is allowed to swing its voltage which will be corrected by the individual power plants' DC/DC converters. In this particular design, power is fed back to batteries and the fuel cells which again, act as capacitors and electrolyzers. The fuel cells can handle a large voltage swing, so a direct path from the DC bus may be obtained by a switch connecting the two positive inputs of the DC/DC converter the fuel cell stack is using to circumvent the latter for higher efficiency. Due to the current sinking limits of the batteries, it's normally not possible to strictly use the motors for all braking purposes, so the system is usually in conjunction with a standard braking mechanism with brake pads.

Internal Combustion Engine—The ICE will be a 3-4 cylinder 4-stroke spark ignition engine either in an inline or flat configuration. Some other attributes it could have are:
Electronically controlled ignition timing
Direct fuel injection
Multiple intake and exhaust valves (per cylinder)
Variable valve timing
Variable compression ratio
It may be super or turbo charged (and this would link to the fuel cell stack's atmospheric O₂ feed)
It may utilize stored O₂ on board the vehicle
Cylinder deactivation
The starter motor for the ICE will be the electric generator

### Operational Controls

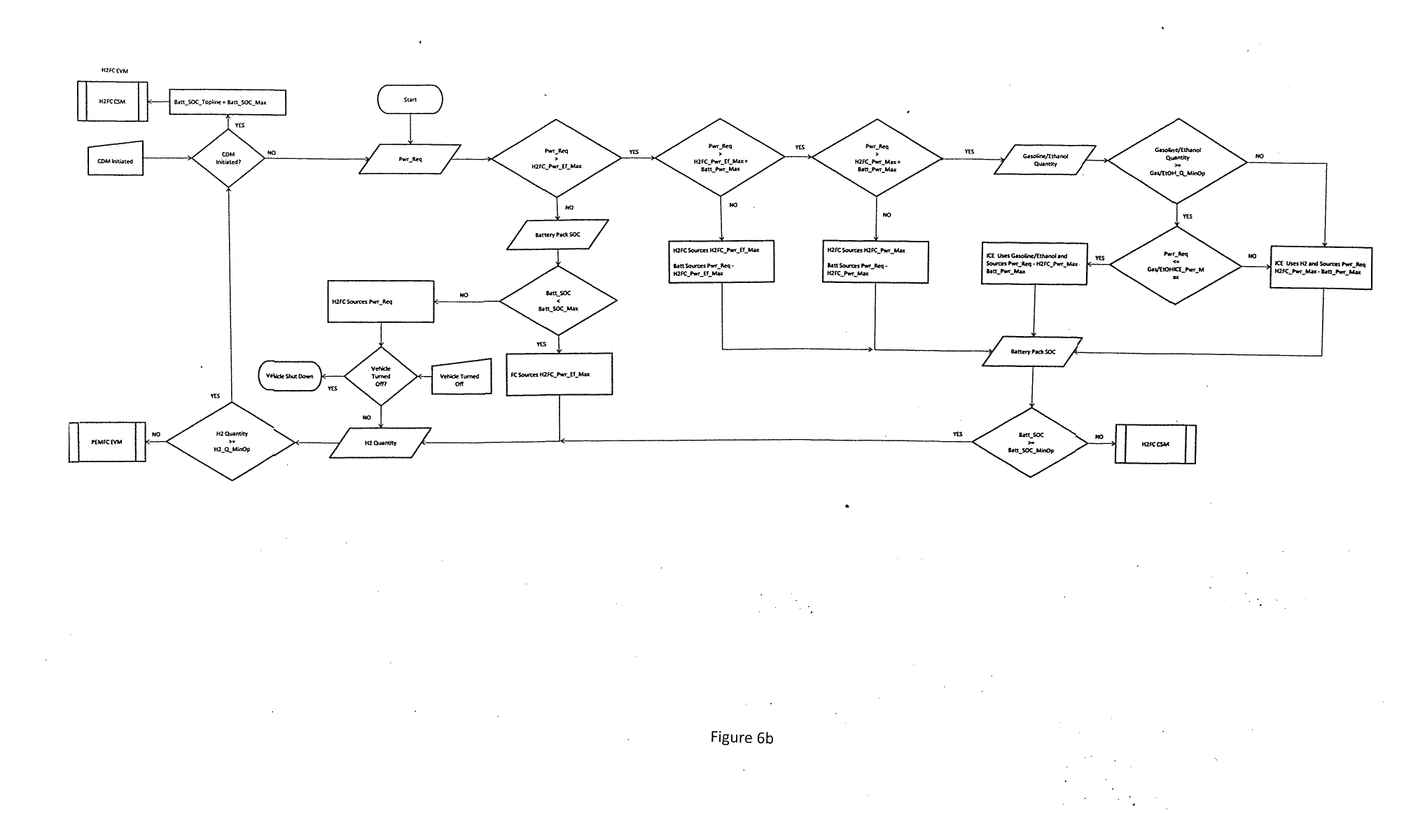

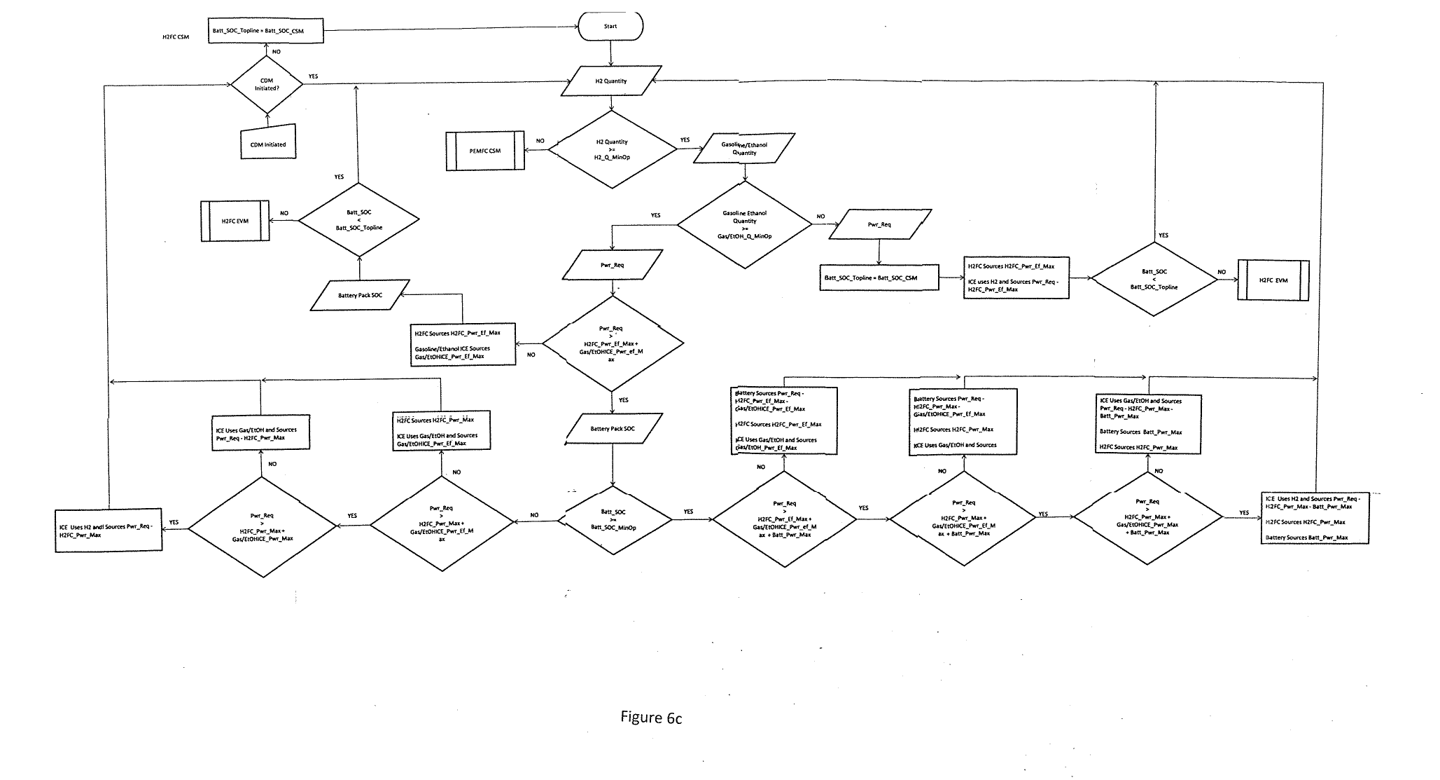

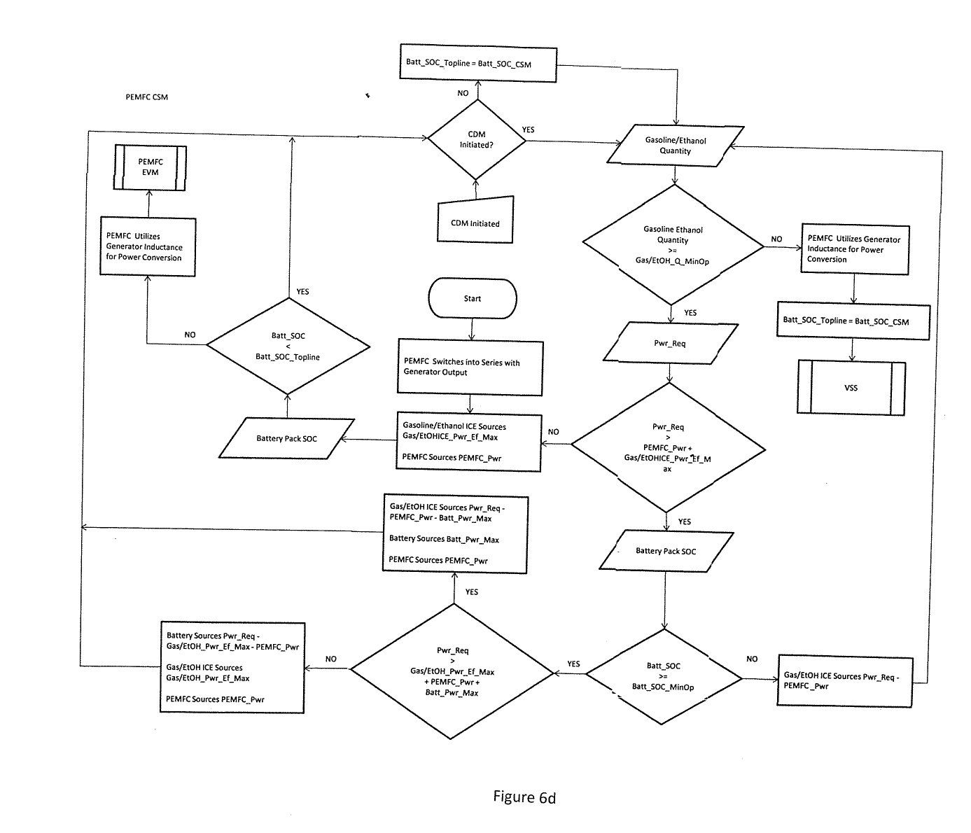

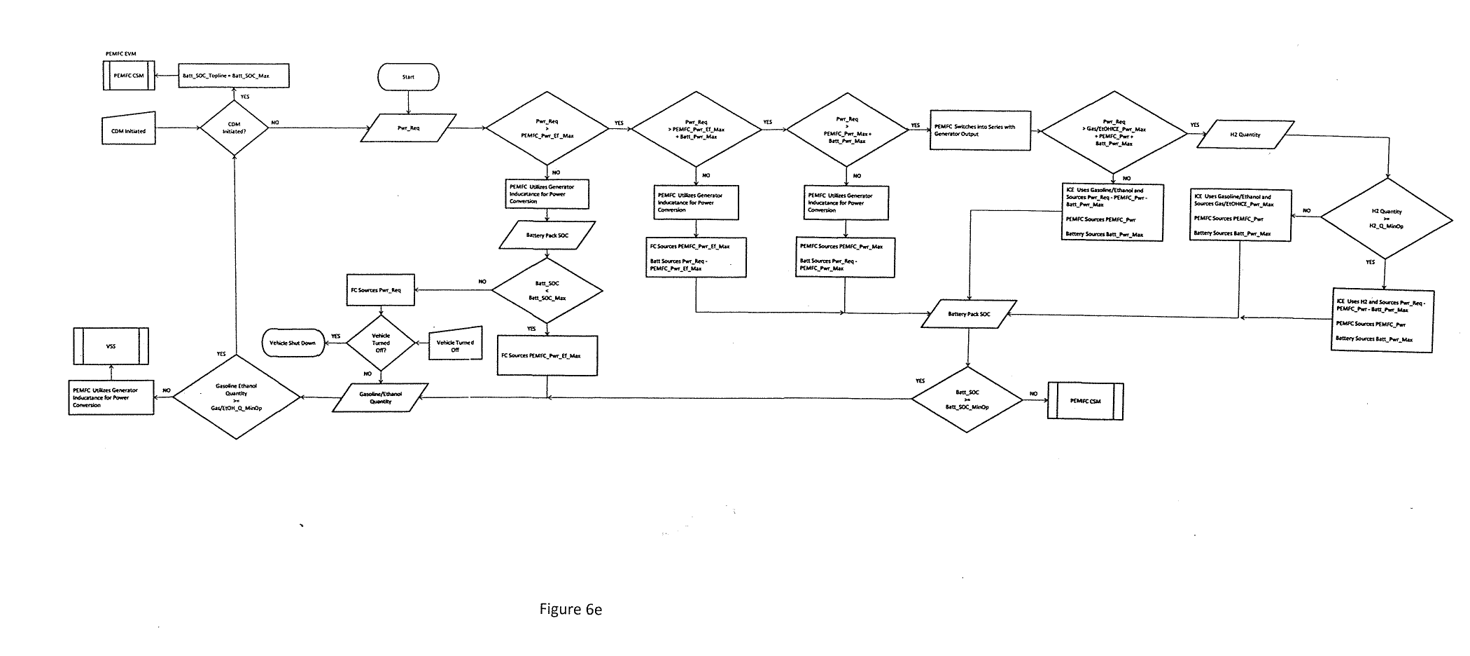

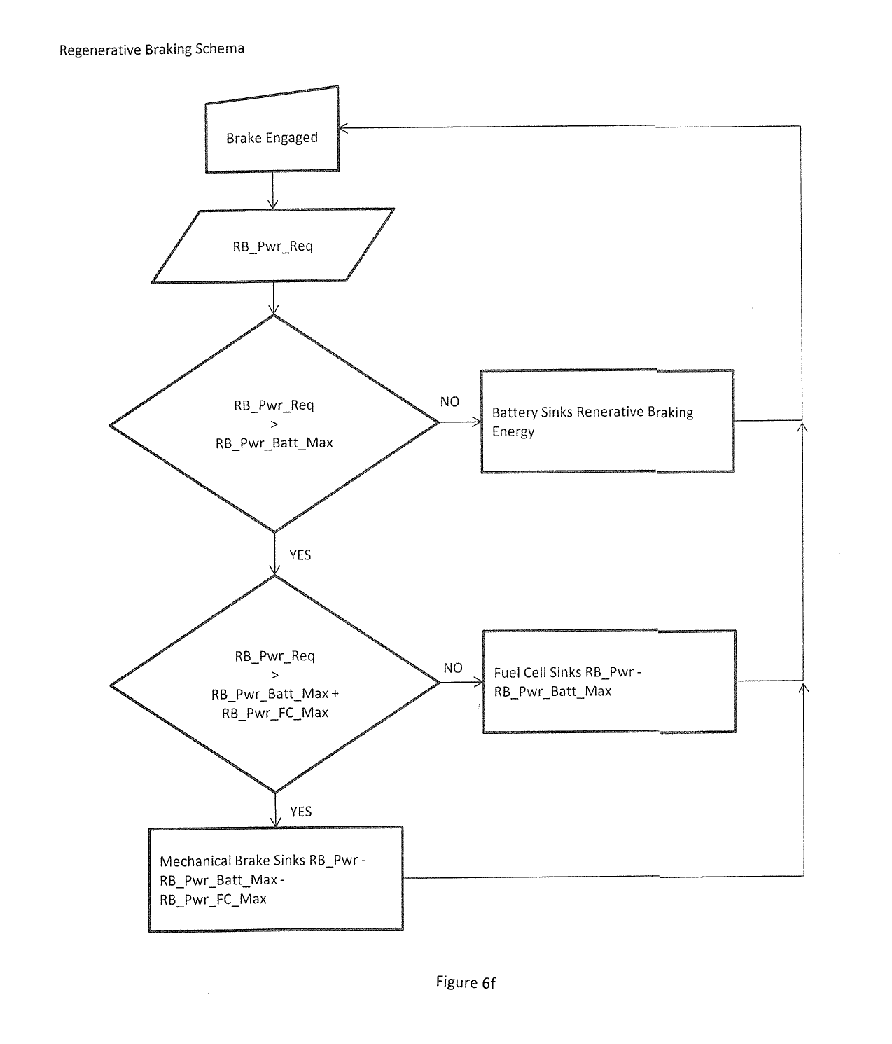

The control schema for a vehicle incorporating a Tri-Hybrid power plant minimizes emissions, utilizes the most cost effective power trains first during operation and allows for all available power trains to be used to source their power together when necessary. Additionally, any combination of available fuel sources will be used until all are depleted. The primary power train of the power plant is the hydrogen fuel cells which always provide power first during propulsion or when sourcing charge to the battery pack. The battery pack is the secondary power train handling large power swings after the maximum power of the fuel cells has been sourced. The ICE is the tertiary power train only supplying power when the other power trains cannot supply what is required, or when the battery SOC is below an operable level. The following flow charts detail the power plant's modes of operation and disclose them in an order that they will most likely occur during vehicle operation. FIGS. 6a to 6f represent schematically the various operational modes of the present invention. Table 1 lists the abbreviations used in FIGS. 6a to 6f.

Vehicle Start Sequence (VSS) is illustrated in FIG. 6a—At the beginning of operation, the power plant first checks to see that hydrogen gas is available so as to immediately feed it into the fuel cells. In the event that there is not enough hydrogen on board, the power plant will try to run the vehicle on gasoline and or ethanol in only the PEMFC providing an ample battery pack SOC. If only the battery pack has energy to propel the vehicle, it will do so until that energy is no longer available and the vehicle must shut down. The start sequence also must check the battery SOC to determine if the power plant will go into either of the charge sustain modes (CSM). Ideally, the vehicle will have hydrogen and an ample battery pack SOC so as to operate in hydrogen fuel cell electric vehicle mode.

Hydrogen Fuel Cell Electric Vehicle Mode (H₂FC EVM) is illustrated in FIG. 6b—This is the most favored power plant configuration as it is most cost efficient and simultaneously produces no emissions with the exception of when high power is needed. The hydrogen fuel cell stack runs at a predetermined maximum efficiency power level and always sources before the battery pack to provide higher power. The fuel cells recharge the battery pack if necessary when the load requirements of the vehicle are below that of the latter power level. The latter happens when the vehicle is turned off by a motorist and is not being recharged with grid energy. This is one of two stationary charging mode configurations. The power plant allows more power to be sourced by successively adding the following available power sources to the fuel cells running at their high efficiency setting: The battery pack, the fuel cells running at their maximum power (low efficiency), the ICE running on gasoline, and finally the ICE running on hydrogen and stored oxygen. More likely than not, the power plant will deplete the battery pack SOC and switch the power plant to operate in hydrogen fuel cell charge sustain mode.

Hydrogen Fuel Cell Charge Sustain Mode (H₂FC CSM) is illustrated in FIG. 6c—This mode essentially attempts to run the hydrogen fuel cells and ICE in tandem in a “thermostat” configuration. Both power trains supply power at their maximum efficiency until the battery pack is brought to a top line SOC where the power plant will revert back to H₂FC EVM until the process repeats. Once the battery back goes above the minimum operable SOC, it will act as a peaking power source. This means it will allow the other two power trains to run at maximum efficiency while it handles power swings. When high power is required, the aforementioned succession of available power trains is followed. Most often, H₂FC CSM will last until the hydrogen fuel cells can no longer source power resulting in the power plant moving to proton exchange membrane fuel cell charge sustain mode.

Proton Exchange Membrane Fuel Cell Charge Sustain Mode (PEMFC CSM) is illustrated in FIG. 6d—The PEMFC now switches into series electrically with the ICE generator output and begins running on gasoline and or ethanol. This combination acts just like the hydrogen fuel cell/ICE combination in a “thermostat” configuration. The aforementioned high power succession is available however without the hydrogen powered sources. The battery again is a peaking power source after it is pushed above its minimum operable SOC. When it reaches its top line SOC, the power plant can move back into electric vehicle mode. Without hydrogen however, the PEMFC running on gasoline or ethanol replaces the hydrogen fuel cells by utilizing the ICE's generator inductance for power conversion.

Proton Exchange Membrane Fuel Cell Electric Vehicle Mode (PEMFC EVM) is illustrated in FIG. 6e—This mode runs in a manner similar to H₂FC EVM. The electrical configuration of the PEMFC must switch into series with the ICE generator output however when high power is required and back to utilizing generator inductance when this is not the case. The PEMFC will recharge the battery pack to its maximum SOC when the vehicle is turned off which will result in the vehicle shutting down. Note that the high power succession includes the ICE running on hydrogen and stored oxygen. This is because during operation, enough of the latter gases may be produced by electrolysis powered by regenerative braking energy.

Regenerative Braking Schema is illustrated in FIG. 6f—The power plant will try to sink as much energy into the battery pack as possible before sinking additional energy into the fuel cell stack's capacitance and to enact electrolysis. When regenerative braking power goes above what the battery and fuel cells can sink, the conventional mechanical brakes engage. The latter happens when the traction motor's (acting as a generator here) power might be below its effective braking ability, like when the vehicle must be held at a stop.

Charge Depletion Mode—The motorist may wish to start the ICE prematurely before the battery pack's SOC is below an operable level. This is because long duration trips might eventually require the ICE to handle large power swings (i.e.—PEMFC CSM) so it is better to prolong this by running the ICE at maximum efficiency in this situation. Like in the CSMs, a “thermostat” configuration is used, but the top line battery pack SOC simply becomes the battery pack's maximum SOC.

Those of ordinary skill in the art will recognize that many obvious modifications may be made to the described embodiment without departing from the spirit or scope of the present invention as set forth in the appended claims.

1. (canceled)

2. A fuel cell stack water relocation mechanism comprising:
An alkaline fuel cell membrane electrode assembly comprising a cathode and anode and cathode flow field that operably consumes water at the cathode and produces water at the anode; and
A proton exchange membrane fuel cell membrane electrode assembly comprising a cathode and anode and cathode flow field that operably consumes water at the anode and produces water at the cathode;
Wherein the alkaline fuel cell cathode flow field is in series with and downstream of the proton exchange membrane fuel cell cathode flow field so that water produced from the proton exchange membrane fuel cell cathode flow field flows to the alkaline fuel cell cathode flow field and the proton exchange fuel cell membrane anode is in series with and downstream of the alkaline fuel cell cathode so that the water produced from the alkaline fuel cell cathode flows to the proton exchange fuel cell membrane anode.

3. A lithium ion battery pack cell balancing mechanism comprising;
A plurality of lithium ion battery cells that store electrical energy;
A water electrolyzer cell or plurality of cells for converting electrical energy into hydrogen and oxygen gas;
A battery management system for monitoring the state of charge and state of health of the lithium ion battery cells and determining the appropriate amount of electrical energy to provide to water contained in the electrolyzer cell or plurality of cells; and
A multiplexor allowing electrical energy to be provided from the lithium ion battery cells into the water electrolyzer cell or plurality of cells;
Wherein the multiplexor creates an electrical connection to source electrical energy from particular lithium ion battery cells into the water electrolyzer cell or cells based on the battery management systems data so as to equalize the state of charge of a subset of the particular lithium ion battery cells in relation to the remaining lithium ion battery cells.

4. A tri-hybrid automotive power plant for powering an automobile comprising:
A traction motor that propels the automobile;
A direct current bus that is electrically connected to power trains and the traction motor;
A lithium ion battery pack that is electrically connected to a direct current bus;
A fuel cell stack that is connected to the direct current bus;
A liquid fuel storage component for storing liquid fuel;
An internal combustion engine that is mechanically connected to an electrical generator that is electrically connected to the direct current bus;
A hydrogen gas storage component for storing hydrogen gas; and
A control device to determine when the lithium ion battery pack, the fuel cell stack, the internal combustion engine mechanically connected to the electrical generator and the traction motor sink or source power to or from the direct current bus;
Wherein the control device determines that the hydrogen storage component has an amount of hydrogen gas greater than a predetermined amount so that the fuel cell stack then supplies power to the direct current bus; and
Thereafter determines the power required by the traction motor is equal to or less than a predetermined power that can be sourced by the fuel cell stack through the direct current bus and determines that the lithium ion battery pack's state of charge is equal to or greater than a predetermined level, so that the fuel cell stack then sources the power required by the traction motor through the direct current bus if the lithium ion battery pack's state of charge is equal to or greater than said predetermined level, sources the power required by the traction motor through the direct current bus and sources the power required to the traction motor through the direct current bus subtracted from said predetermined power that can be sourced from the fuel cell stack to the lithium ion battery pack if the lithium ion battery pack's state of charge is less than said predetermined level; and
Thereafter determines the power required by the traction motor is greater than a predetermined power that can be sourced by the fuel cell stack through the direct current bus, so that then the fuel cell stack sources the predetermined power to the traction motor through the direct current bus and the lithium ion battery pack sources to the traction motor through the direct current bus the predetermined power sourced from the fuel cell stack through the direct current bus subtracted from the power required by the traction motor through the direct current bus; and
Determines that the lithium ion battery pack's state of charge is equal to or less than a predetermined minimum level and that the hydrogen gas storage component has an amount of hydrogen gas that is greater than the predetermined amount; and
Thereafter determines the power required by the traction motor through the direct current bus, and sources a predetermined power from the internal combustion engine through the electrical generator and sources a predetermined power from the fuel cell stack to the direct current bus, so that then;
The power required by the traction motor is sourced to the traction motor from the direct current bus and the power required by the traction motor through the direct current bus subtracted from the sum of said powers from the internal combustion engine through the electrical generator and the fuel cell stack is sourced to the lithium ion battery pack through the direct current bus if the power required by the traction motor is equal to or less than the sum of the powers;
The sum of the powers is sourced to the traction motor plus an additional amount of power sourced by the internal combustion engine through the electrical generator through the direct current bus up to a predetermined maximum power sourced by the internal combustion engine if the power required by the traction motor is greater than the sum of the powers; and
Thereafter determines the lithium ion battery pack's state of charge is equal to or greater than a predetermined maximum level and that the hydrogen gas storage component has an amount of hydrogen gas greater than the predetermined amount, so that then;
The internal combustion engine no longer sources power through the electrical generator through the direct current bus and the control device reverts to the control strategy of paragraph i.

5. The tri-hybrid automotive power plant of claim 4 wherein;
The lithium ion battery pack is connected to an external source of electrical energy to bring the state of charge of the lithium ion battery pack to a maximum predetermined level.

6. The tri-hybrid automotive power plant of claim 4 comprising;
The internal combustion engine combusts hydrogen ethanol, gasoline, or any mixture of ethanol and gasoline.

7. The tri-hybrid automotive power plant of claim 4 further comprising;
A fuel cell stack of a cylindrical architecture.

8. The tri-hybrid automotive power plant of claim 4 wherein;
The fuel cell stack is an alkaline fuel cell stack.

9. The tri-hybrid automotive power plant of claim 8 further comprising;
A liquid fuel cell electrolyte flow field connected to a valve for removing liquid fuel cell electrolyte and potassium carbonate from the vehicle and replacing it with fresh liquid fuel cell electrolyte.

10. The tri-hybrid automotive power plant of claim 4 further comprising;
An alkaline fuel cell stack;
A switched proton exchange membrane fuel cell that moves electrically in series with rectified electrical generator voltage or the alkaline fuel cell stack;
A control device to determine when the proton exchange membrane fuel cell will be electrically in series with the rectified electrical generator voltage or the alkaline fuel cell stack;
Wherein said control device:
Determines that the amount of hydrogen in the hydrogen storage component is below a predetermined level so that then the proton exchange membrane fuel cell is switched electrically in series with the rectified electrical generator voltage and flows liquid fuel from the liquid fuel storage component into the anode flow field of the proton exchange membrane fuel cell; and
Determines that the amount of hydrogen in the hydrogen gas storage component is above a predetermined level so that then the remaining liquid fuel in the proton exchange membrane fuel cell anode flow field is expelled and the proton exchange membrane is moved electrically in series with the alkaline fuel cell stack.

11. The tri-hybrid automotive power plant of claim 4 further comprising:
A water electrolyzer cell for converting water into oxygen gas and hydrogen gas that is connected to a direct current bus; and
An electrical connection from the electrolyzer to an electrical port that can be connected to an external source of electrical power for converting water into hydrogen and oxygen gas.

12. The tri-hybrid automotive power plant of claim 11 further comprising:
A regenerative braking mechanism control device that determines that the power being sourced from the traction motor through the direct current bus is equal to or less than a predetermined maximum power that the lithium ion battery pack can sink, so that the traction motor then sinks the power being sourced from the traction motor through the direct current bus into the lithium ion battery pack if the power being sourced from the traction motor is equal to or less than the predetermined maximum power; and
Thereafter determines that the power being sourced from the traction motor through the direct current bus is less than or equal to the predetermined maximum power that the lithium ion battery pack can sink plus a predetermined maximum power the electrolyzer can sink, so that the traction motor then sinks the predetermined maximum power through the direct current bus into the lithium ion battery pack and sinks the predetermined maximum power being sourced from the traction motor through the direct current bus subtracted from the power being sourced from the traction motor into the electrolyzer; and
Thereafter determines that the power being sourced from the traction motor is equal to the predetermined maximum power that the lithium ion battery pack can sink plus a predetermined maximum power that the electrolyzer can sink, then sinks the predetermined maximum power being sourced from the traction motor through the direct current bus into the lithium ion battery pack and sinks the predetermined maximum power being sourced from the traction motor through the direct current bus into the electrolyzer.

13. The tri-hybrid automotive power plant of claim 11 further comprising:
An oxygen storage component for storing oxygen gas produced by the water electrolyzer;
An oxygen flow field for feeding oxygen gas into the fuel cell stack's cathode flow field to produce electrical energy; and
An oxygen flow field for feeding oxygen gas into the internal combustion engine's cylinders to produce mechanical energy.

14. A series electric vehicle automotive power plant power converter comprising:
An internal combustion engine that is mechanically connected to an electrical generator that is electrically connected to a direct current bus;
An electrochemical power train connected to the direct current bus;
A multiphase pulse width modulated rectifier/inverter for rectifying or inverting the electrical power produced by the electrical generator and connected to the direct current bus comprising;
An electrical switch or switches for connecting or disconnecting the positive node of a first transistor from the direct current bus and the positive nodes of a plurality of other transistors connected to the direct current bus;
An electrical switch or switches for connecting or disconnecting the positive node of the electrochemical power train to the positive node of the first transistor;
A control device controlling switches and gates or bases of said transistors and the remaining transistors in the rectifier/inverter;
Wherein said control device simultaneously applies electrical signals to the switches for connecting the positive node of the electrochemical power train to the positive node of the first transistor, applies electrical signals to turn off all rectifier/inverter transistors connected to the negative node of the direct current bus and applies an electrical signal to turn on all rectifier transistors connected to the positive node of the direct current bus and applies an electrical signal to repeatedly turn on and off the first transistor so as to open and close an electrical path from the electrochemical power train through the first transistor through the electrical generator and onto the direct current bus.
A copy of the claims and their status is attached hereto as Exhibit 1.
